(19) United States
(12) Patent Application Publication
(10) Pub. No.: US 2006/0071600 A1
(43) Pub. Date: Apr. 6, 2006

(54) Electric reflector lamp and assembling process therefore

(75) Inventor: Cornelis Versluijs, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/534,074

(22) PCT Filed: Oct. 21, 2003
(86) PCT No.: PCT/IB03/04665

§ 371 Date: May 6, 2005

(30) Foreign Application Priority Data
Nov. 11, 2002 (EP) 02079687.6

(51) Int. Cl. H01J 61/30; H01J 17/16

(52) U.S. Cl. 313/634

(57) ABSTRACT

Process for assembling an electric reflector lamp comprising: molding a hollow reflector body having an optical axis and having a neck-shaped portion with a transverse wall provided with at least one opening; providing a light source and arranging the light source in the reflector body; electrically connecting the light source to a lamp cap provided with contacts and with a current conductor comprising a pliable material, which conductor is passed through the opening in the transverse wall;wherein, the position of the light source is secured in at least one longitudinal direction by bending of the conductor around at least a portion of the outer transverse wall.

The invention relates to a process for assembling an electric reflector lamp comprising: molding a hollow reflector body having an optical axis and having a neck-shaped portion with a transverse wall provided with at least one opening; providing a light source and arranging the light source in the reflector body; and electrically connecting the light source to a lamp cap provided with contacts and with a current conductor comprising a pliable material, which conductor is passed through the opening in the transverse wall.

A reflector lamp resulting from said process is known from WO 96/07193.

During assembly of the known electric reflector lamp, the position of the light source is arranged in the reflector body to be optimal with the reflecting properties of the body. The current conductors running through the openings in the transverse walls are secured in place by crimping to brass bushings clamped in the neck part of the reflector in the transverse wall. This locks the light source in the axial direction. The lamp cap is then connected to the current conductor or the bushings.

Such bushings are also known from EP 0491432.

A drawback in the assembly of these reflector lamps is, however, that the bushings are not well fixed due to thermal expansion differences between the glass and the brass.

It is an object of the invention to provide a process for assembling an electric reflector lamp in which the position of the light source is secured without experiencing the thermal expansion differences.

According to the invention, this object is achieved by securing the position of the light source in at least one longitudinal direction in that the conductor is bent around at least a portion of the outer transverse wall. This results in leaving out the bushings during assembly, so that no thermal expansion differences can occur. Bending the conductor is possible due to the pliability of the material. The current conductor comprises, for example, a metal or another flexible conducting material.

In the preferred embodiment, the position of the light source is secured so as to be parallel to the direction of the optical axis by means of a mounting member. The mounting member arranges and secures the position of the light source in line with the optical axis.

In the preferred embodiment, the position of the light source in the longitudinal direction is secured in that the mounting member is made to rest on the inner conical contour of the neck. The conical contour causes a fixation of the mounting member in the neck on one side. The curved conductor secures a fixing in the other longitudinal direction. The inner neck portion can be provided with references that cooperate with the mounting member, thus securing the alignment with the optical axes.

The invention also relates to an electric reflector lamp comprising:

a hollow molded reflector body having an optical axis and having a neck-shaped portion with a transverse wall provided with at least one opening;

a lamp cap provided with contacts and connected to the neck-shaped portion;

a light source in a lamp vessel with a seal, arranged in the reflector body, and electrically connected to the contacts of the lamp cap by means of current conductors comprising a pliable material, running through the opening in the transverse wall;

a securing means for securing the position of the light source in the longitudinal direction.

Such an electrical reflector lamp is known from WO 96/07193. In the known lamp, the securing means comprises bushings crimped to fix the conductor and the light source in the longitudinal direction, which bushings are clamped in the openings of the transverse wall.

According to the invention, the current conductor forms the securing means. This saves the use of the bushing and overcomes any thermal expansion differences occurring between the bushings and the glass of the lamp.

In a preferred embodiment, the conductor comprises a bend. In the preferred embodiment, the conductor is at least partly adjacent or parallel to the outer transverse wall. The bend in the conductor causes the conductor to secure the position of the light source in at least one longitudinal direction. The bend fixes the light source by prohibiting the distance between the transverse wall and the light source to enlarge. Since the conductor comprises a pliable material, a bend can be applied.

In a favorable embodiment, the conductor comprises a deformable material. This causes the bend to be more permanent and sustainable.

The electric reflector lamp may comprise a mounting member, preferably of metal, for securing the position of the light source parallel to the optical axis. In the preferred form, the mounting member is arranged around the seal of the lamp vessel. The mounting member may be mounted in the neck-shaped portion. The mounting member aligns the light source with the optical axis. The mounting member comprises a bore in which the seal of the light source, for example a lamp vessel, is accommodated. The mounting member is a substantially flat plate. The mounting member is mounted in the neck-shaped portion.

In the preferred embodiment, the securing means for the light source parallel to the optical axis comprises the mounting member and the inner conical portion of the neck. The inner conical wall of the neck is provided with references which cooperate with the mounting member. The mounting member may be arranged in the conical neck and may sink into the neck until the diameter of the mounting member is substantially equal to the diameter of the neck. This secures the positioning in one direction along the optical axis. Securing in the other direction is performed by the bend in the connection wire.

It is noted that e.g. securing the longitudinal position by connecting the conductor to the lamp cap does not make the conductor a securing means, the connection in this case would be the securing means. According to the invention, the conductor itself forms the securing means. The conductor replaces the connection, e.g. the bushing.

An embodiment of the electric reflector lamp is shown in the drawing, in which;

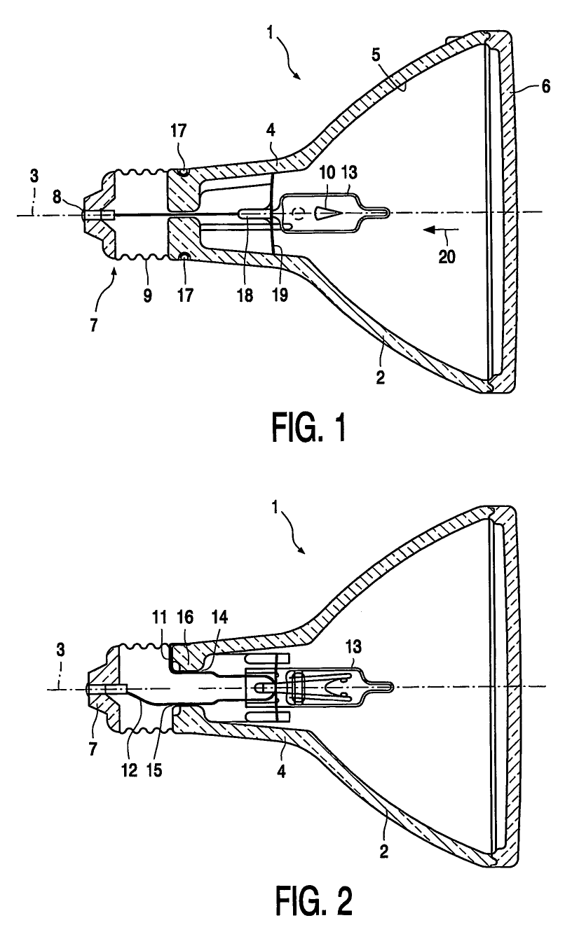

FIG. 1 is an axial section of the lamp;

FIG. 2 shows the lamp of figurine rotated through 90°.

In FIG. 1 and 2, the electric reflector lamp 1 has a hollow molded reflector body 2, for example molded from glass, with an optical axis 3 and a neck-shaped portion 4. The reflector body has a mirror coating, for example internally, for example a vapor-deposited aluminum layer 5, but alternatively a dichroic mirror. The reflecting surface is smoothly curved. Alternatively, however, it may be faceted or subdivided into, for example, axial lanes. The reflector body 2 is closed off by a lid 6, for example made of molded glass, which is fixed, for example, with cement. A lamp cap 7 provided with contacts 8,9 is connected to the neck-shaped portion. A light source 10 is arranged in the reflector body 2 and electrically connected to the contacts 8,9 of the lamp cap 7 by means of current conductors 11, 12. In the figures, the light source 10 is an incandescent body 10 in a gas comprising halogen in a lamp vessel 13. The current conductors 11,12 run through respective openings 14, 15 in a transverse wall 16 in the neck-shaped portion 4. The neck-shaped portion 4 has an indentation 17 into which the lamp cap 7 is dimpled so as to be securely fixed. The lamp vessel 13 has a seal 18 which is accommodated in a metal mounting member 19, a substantially flat plate in the figures. The mounting member 18 is mounted in the neck-shaped portion 4, whose inner walls are conically shaped. This is also preferable for the disengagement of the body from the mold in which the body is formed.

On the outer side of the transverse wall 16, part of electric conductor 11 runs adjacent to the outer wall. The electrical conductor has a bend near the opening 14. The deformable character of the conductor prevents the wire from returning to a straight shape.

During assembly of the reflector lamp, the light source 10 is introduced into the neck of the body 2 along arrow 20. The mounting member 12 is in place around the seal 18. The mounting member 19 works together with the conical inner side of the neck-shaped portion 4. Light source 10 is in line with the optical axis 3. Continuing the movement along arrow 20 is prevented at a certain stage by the conical neck. The light source is then in a position parallel to the optical axis. The light source 10 can only be moved in a direction opposite to arrow 20.

The connecting wires 1 land 12 extend through the openings 14 and 15, before the lamp cap 7 is arranged. When the light source 10 is in place and cannot be moved further into the neck-shaped portion 4 along arrow 20, one of the connecting wires, according to FIG. 2 connecting wire 11, is bent along the outside of the transverse wall 16, so as to be partially adjacent or parallel to this outer transverse wall. Thereafter the conductor wires are connected to the lamp cap contacts 8,9. The lamp cap is fixed in position by means of the indentations 17.

Assembly according to the invention saves costs on components and assembling costs.

Part of the invention is the recognition that the conductor wire is strong enough to secure the light source position. It is also part of the invention to replace welding or clamping by bending during assembly.

Other embodiments of a reflector lamp according to the invention are possible. It is possible to use only one opening in a transverse wall. It is possible to use separate wires from the light source or burner for connecting to the lamp cap.

1. Process for assembling an electric reflector lamp comprising:
molding a hollow reflector body having an optical axis and having a neck-shaped portion with a transverse wall provided with at least one opening;
providing a light source and arranging the light source in the reflector body;
electrically connecting the light source to a lamp cap provided with contacts and with a current conductor comprising a pliable material which conductor is passed through the opening in the transverse wall;
characterized by a step of
securing the position of the light source in at least one longitudinal direction in that the conductor is bent around at least a portion of the outer transverse wall.

2. Process according to claim 1, characterized in that the position of the light source is secured so as to be parallel to the direction of the optical axis by means of a mounting member.

3. Process according to claim 2, characterized by a step of securing the position of the light source in the longitudinal direction in that the mounting member is made to rest on the inner conical contour of the neck.

4. Process according to claim 1, characterized by a step of pulling the light source in the reflector neck.

5. Process according to claim 1, characterized in that at least one of the conductors is bent through a sharp angle of approximately 90°, so as to lock the light source in the axial direction.

6. An electric reflector lamp comprising:
a hollow molded reflector body having an optical axis and having a neck-shaped portion with a transverse wall provided with at least one opening;
a lamp cap provided with contacts and connected to the neck-shaped portion;
a light source in a lamp vessel with a seal, arranged in the reflector body and electrically connected to the contacts of the lamp cap by means of current conductors that comprise a pliable material and are passed through the opening in the transverse wall;
a metal mounting member for securing the position of the light source in the optical axis direction, arranged around the seal of the lamp vessel and mounted in the neck-shaped portion,
a securing means for securing the position of the light source in at least one longitudinal direction
characterized in that,
said current conductor forms the securing means.

7. Electric reflector lamp according to claim 6, characterized by, a bend in the conductor so that the conductor is at least partially adjacent to the outer transverse wall.

8. Electric reflector lamp according to claim , characterized in that the conductor comprises a deformable material.

9. Electric reflector lamp according to claim 6, characterized by a sharp bend in the conductor of approximately 90°.
